(19) United States
(12) Patent Application Publication
(10) Pub. No.: US 2022/0076274 A1
(43) Pub. Date: Mar. 10, 2022

(54) DESCRIPTIVE ONSET PACKAGING

(71) Applicant: Radient Technologies Innovations Inc., Edmonton (CA)

(72) Inventors: Michael Cabigon, Edmonton (CA); Jim Seethram, Edmonton (CA); Steven Splinter, Edmonton (CA); Denis Taschuk, Edmonton (CA)

(21) Appl. No.: 17/239,790

(22) Filed: Apr. 26, 2021

Related U.S. Application Data
(63) Continuation of application No. PCT/IB2019/058961, filed on Oct. 22, 2019.
(60) Provisional application No. 62/750,198, filed on Oct. 24, 2018.

(51) Int. Cl. G06Q 30/00; G06Q 30/06; G06Q 30/02; G06F 16/23

(52) U.S. Cl. CPC G06Q 30/018; G06Q 30/0631; G06F 16/2358; G06Q 30/0203; G06Q 30/0201

(57) ABSTRACT

A system and method for providing a Cannabis product with a product label describing the onset of effects. The product label may include key consumption information such as time after consumption until the product takes effect, types of effects, time until effect subsides, effect on other functions (e.g., sleep, eating, working, reading), and best use cases for the Cannabis product. The system may include crowdsourcing data of Cannabis product effects from users to determine the effect to the average user. In some embodiments, the label may describe separate effects for users at various levels of tolerance.

### CROSS-REFERENCE TO RELATED APPLICATIONS

The present patent application is a continuation of International Application No. PCT/IB2019/058961 filed Oct. 22, 2019, which claims the priority benefit of U.S. provisional patent application 62/750,198 filed Oct. 24, 2018, the disclosures of which are incorporated by reference herein.

### BACKGROUND OF THE INVENTION

### 1. Field of the Disclosure

The present disclosure is generally related to Cannabis product labels and more specifically related to crowdsourcing Cannabis product labels for descriptive onset of effects.

### 2. Description of the Related Art

Labeling Cannabis products correctly is of huge importance. Mislabeling Cannabis products can cause great harm to users. Many dispensaries and online stores are currently offering mislabeled Cannabis products that have incorrect information in regards to their potency. Certain states, such as California, have introduced law regarding the packaging of Cannabis to address the rampant mislabeling and lack of uniformity of product labeling among growers, producers, and retail sellers of Cannabis. Such exemplar laws would require a thorough investigation into the potency mislabeling issues. For example, California's investigation in such safety concerns have resulted in the discovery that nearly a fifth of products retailing in California's dispensaries were found to be falsely labeled, as 18% of the products in California have failed tests for potency (concentration of cannabinoids such as tetrahydrocannabinol (THC) and cannabidiol (CBD)) and purity. Of the 11,000 samples that were tested, almost 2,000 failed.

Testing is especially poor on infused products. Examples of infused products are Cannabis infused brownies, tinctures, extracts, and similar products, which are traditionally very potent. Reports indicated that nearly a third of those products should be removed from the retail market for labeling that claimed levels of cannabinoids that were different from what was found during testing. False claims of THC contents accounted for 65 percent of the failures as 1,279 out of a total of 10,695 tests failed. Most importantly, there is evidence that the growers are correctly testing and labeling the Cannabis flowers prior to processing. For example, in California, approximately 90% of the Cannabis flowers tested turned out to be factually correct when compared to its label, indicating a mostly accurate labeling by the growers.

Another factor to mislabeling is that testing products (e.g., analytical chemistry testing for potency) can be cost prohibitive for small Cannabis farms and manufacturers. Costs of testing products for small Cannabis grow operation can range around $5,000 to $10,000 USD depending on the number of products and testing locations. For California, the mandatory testing of Cannabis is conducted by the California Bureau of Cannabis Control, which is a state government body. However, such uniformity is not necessarily available in other states or countries.

Labels on Cannabis product are also subject to government-required health disclosures. For example Health Canada released its proposals for Cannabis packaging that requires a standardized Cannabis warning symbol and a series of government-mandated messages warning of the potential health risks of Cannabis. Such messages may be “WARNING: Cannabis can be addictive,” “Up to 1 in 2 people who use Cannabis daily will become addicted,” “WARNING: Adolescents are at greater risk of harms for Cannabis,” or “Early and regular use increases the risk of psychosis and schizophrenia.” These warnings may be useful in conveying the long-term health implications of Cannabis use but do very little to address the specific onset of effects associated with consuming the Cannabis product.

There exists a need to provide Cannabis users with a product label that accurately describes the onset of effects associated with the consumption of a specific Cannabis product. Health and safety labels are a necessary feature of a Cannabis product label but do little to inform a medical or recreational user of relative effects of different Cannabis products. Allowing product manufacturers to create their own labeling schema is likely to disjoint the Cannabis recreational product labeling market, making it difficult for users to compare products from different manufacturers. Furthermore, there exists a need to provide users with a standardized labeling system to compare various Cannabis products, report products that are mislabeled, and provide feedback to the labeling system to improve labels over time. Such a system should allow product manufacturers to include a standard effects label on their Cannabis product, where data for the label may be collected by a focus group or crowdsourced by various Cannabis consumers who can provide feedback to the labeling system.

### BRIEF DESCRIPTIONS OF THE DRAWINGS

FIG. 1 illustrates an exemplary network environment in which a system for providing a Cannabis product with a product label describing the onset of effects may be implemented.

FIG. 2 is a table illustrating exemplary data that may be included in the label database.

FIG. 3 is a flowchart illustrating an exemplary method for receiving user submitted descriptions of the onset of effects.

FIG. 4 is a flowchart illustrating an exemplary method for comparing the onset of effects.

FIG. 5 is a table illustrating exemplary user data that may be included in the user database.

FIG. 6 is a flowchart illustrating an exemplary method updating the onset of effect descriptions through communications with the manufacturer.

FIG. 7 is a flowchart 700 illustrating an exemplary method for the user to access and upload descriptions of the onset of effects.

FIG. 8 is a flowchart illustrating an exemplary method for the user to track consumption of Cannabis products.

FIG. 9 is a flowchart illustrating an exemplary method for updating the manufacturer's product label

### DETAILED DESCRIPTION

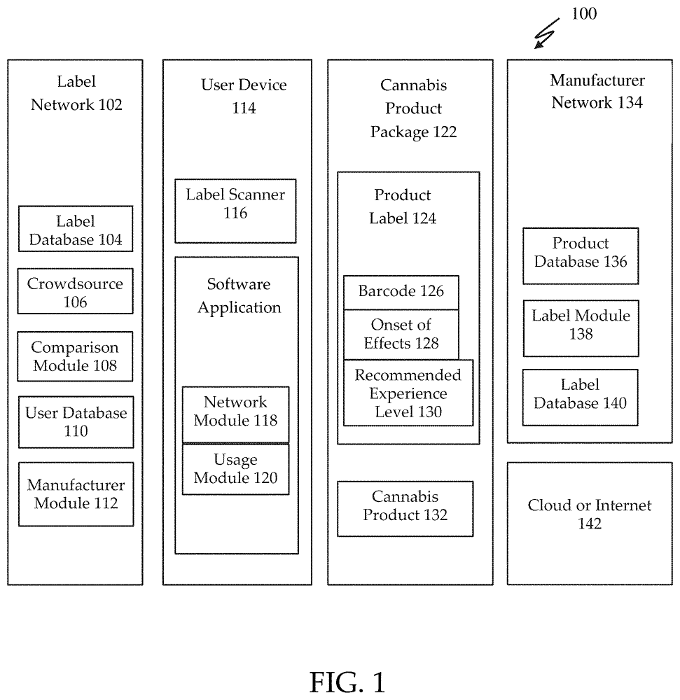

Embodiments of the present disclosure include systems and methods for providing Cannabis product labels describing the onset of effects. FIG. 1 is a block diagram illustrating an exemplary system 100 for providing a Cannabis product with a product label describing the onset of effects. This system 100 may include a label network 102, a user device 114, a Cannabis product package 122, a manufacturer network 134, and a cloud or internet 142. The term “cloud” and “internet” may be used synonymously. The cloud or internet 142 may connect the label network 102, user device 114, and manufacturer network 134 via a wireless connection.

The system 100 may be understood as a network in the cloud or internet that may aggregate data from several sources that result in producing a Cannabis product label that accurately describes the onset of effects of a particular Cannabis product. For example, one of the possible sources of this data is from users who submit descriptions of the onset of effects after consuming the Cannabis product through the label network 102. Other users may also use the label network 102 to access the aggregated data.

The label network 102 may consist of a label database 104, a crowdsource software module 106, a comparison module 108, a user database 110, and a manufacturer software module 112. The label database 104 may include a database of information that may be placed on Cannabis product labels. Such information may include the onset of effects of the labeled products, and other Cannabis product data such as ingredients, testing results, user reviews, etc. The crowdsource software module 106 may then receive user submitted descriptions of the onset of effects, aggregating the descriptions, and comparing the description to the current product label to determine if the product label must be updated. The comparison software module 108 may then compare the collected data on the onset of effects for particular Cannabis from the crowdsource module 106 to predict whether a user will likely favorably tolerate that particular Cannabis product based on the user's profile (e.g., experience level) in the user database 110. For example, after analyzing a user's profile and a Cannabis product aggregated data, the comparison module 108 may indicate that the product is not recommended for the user because of the user's experience level.

The user database 110 may include a database of users and a profile for each user, which may include data on each user's experience level, history of Cannabis usage, and previously submitted descriptions of the onset of effects of Cannabis products. The manufacturer software module 112 may receive product data from a Cannabis product manufacturer, provide labeling guidelines to the manufacturer for a product label that describes the onset of effects, and allow the manufacturer data associated with a specific product to be scanned and reviewed by users of the label network 102.

The user device 114 is a device that may contain a label scanner 116 that is capable of scanning Cannabis product labels, and that is capable of downloading and executing a software application that may include a network module 118, and a usage module 120. Once the user device 114 downloads the software application, the user device 114 may then be used to retrieve product data, input descriptions of the onset of effects, and track the user's history of Cannabis usage. The label scanner 116 may allow a Cannabis product label to be scanned to connect with the network module 118 to retrieve the data associated with the scanned product. Examples of possible technology in a user device 114 that may operate as a label scanner 116 may include a camera, optical sensor, barcode scanner, NFC, RFID, or some other method of scanning a label for a unique product code.

The network module 118 is a software module of an application on the user device 114 that may retrieve product data from the label network 102 and send user data including a description of the onset of effects to the label network. The usage module 120 is a software module of an application on the user device 114 that allows the user to input and track the user's Cannabis usage and experience. The usage module 120 may be connected with the network module 118 to provide the user inputted usage data to the label network 102, allowing the label network 102 to compare the user's history of consumption/usage.

The Cannabis product package 122 is a package that contains the Cannabis product 132 and product label 124. The package 122 can be in any number of forms. For example, the package may be a bag, tote, box, rigid packaging, medical bottle, food wrapper, or some other method of packaging a Cannabis product that allows a label to be affixed. The product label 124 is label that contains information that is unique to the Cannabis product that the label is affixed to. The information on the product label 124 may include a barcode or similarly scan-able feature 126, a description of the onset of effects 128, and a recommended user experience level 130. The scan-able portion 126 of the product label 124 may allow the user to retrieve product information from the label network 102, compare the user's history of Cannabis usage, and allow the user to submit a description of the onset of effect.

The product label's description of Cannabis effects 128 may include the time from consumption when effects may first present, the sensations associated with the onset of effects (e.g., physical, psychological/emotional), the recommendation of activities most suitable during the onset of effects, and the time from consumption when the effects may begin to dissipate. The recommended experience level 130 of the product label 124 is a recommendation of the level of experience the user should have before consuming the Cannabis product. Some examples of experience level may include beginner, intermediate, expert, high tolerance, very high tolerance/Cannabis resistant, and the regularity or quantity the user typically consumes (e.g., daily, weekly, monthly, yearly consumer, 1 gram of Cannabis per day, week, or month, etc.). The Cannabis product 132 is the product described by the product label and contained within the packaging. The product 132 may be whole Cannabis plant, dried Cannabis flower, pre-rolled Cannabis cigarettes, Cannabis extract, concentrate or oil, a Cannabis food or beverage product, tincture, patch, vaporizing liquid, topical ointment, crystallized powder, wax or resin, etc.

The manufacturing network 134 may include a product database 136, a label module 138, and a label database 140. The manufacturer network 134 may be a network in the cloud that allows a product manufacturer to send product data from the product database 136 to the label network 102 to be accessed by the user via the user device 114. The manufacturing network 134 may also receive from the label network 102 labeling guidelines for each product, which may then be stored in the label database 140.

The product database 136 is a database on the manufacturer network 134 that contains product data for each Cannabis product produced by a manufacturer. The label module 138 is a software module of the manufacturer network 134 that allows the manufacturer network 134 to send product data to the label network 102. The label network 102 may then internally test, review, or allow users to test and review the specific Cannabis product. After testing and reviewing, the label network 102 may then provide the manufacturer network 134 with labeling guidelines for the specific Cannabis product. The label database 140 is a database of product label guidelines received from the label network 102 that also identifies the associated product in the product database 136.

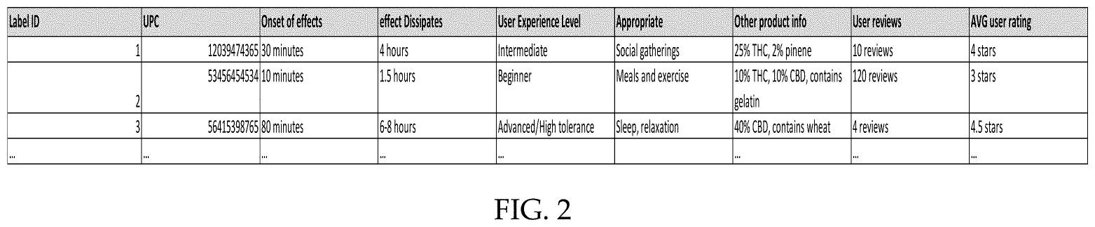

FIG. 2 is a table illustrating exemplary data that may be included in the label database 104. The database may include a label identifier, a product code (e.g., “UPC”), the time from consumption when the onset of effects may begin, the time from consumption when the effects may begin to dissipate, the user experience level, the recommended appropriate activities to do while under the effects, other Cannabis product data (e.g., ingredients), user reviews, and average user ratings.

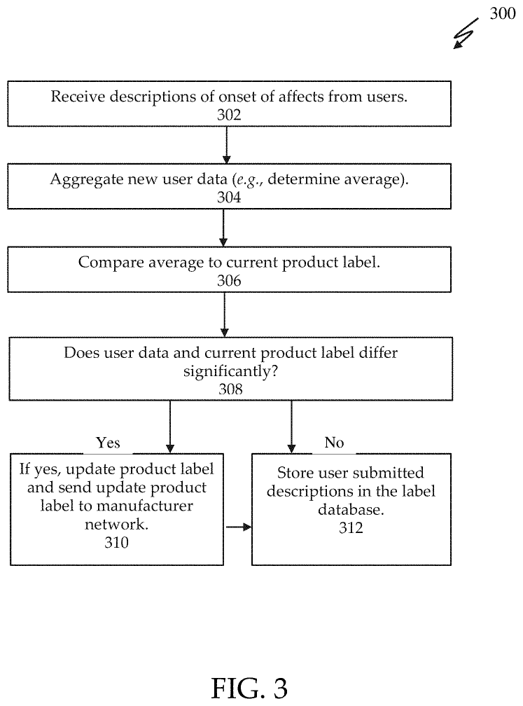

FIG. 3 is a flowchart illustrating an exemplary method 300 for receiving user submitted descriptions of the onset of effects. Method 300 begins with the label network 102 receiving descriptions of onset of effects from users at 302. The description may include time until effects onset, time until effects dissipate, user experience level, appropriate activities, the user's rating of the product (e.g., 1 to 5 stars). The crowdsource module 106 will aggregate and process new user data (e.g., determine an average) for each factor submitted by users at step 304. The crowdsource module 106 will then compare the average of all users-submitted data to the current product label at step 306. The average may be obtained by analyzing the standard deviation of each factor through a mathematical method and may be based on the number of users as the sample size of observations. Next, the comparison module 108 will determine whether the user data and current product label differ significantly (e.g. deviation by 2 standard deviations) at step 308. If there is a significant difference, the crowdsource module 106 will update the product label in the label database 104 and send updated product label guideline to the manufacturer network 134 via the manufacturer module 112 at step 310. If not, the user-submitted descriptions will be stored in the label database 104 at step 312.

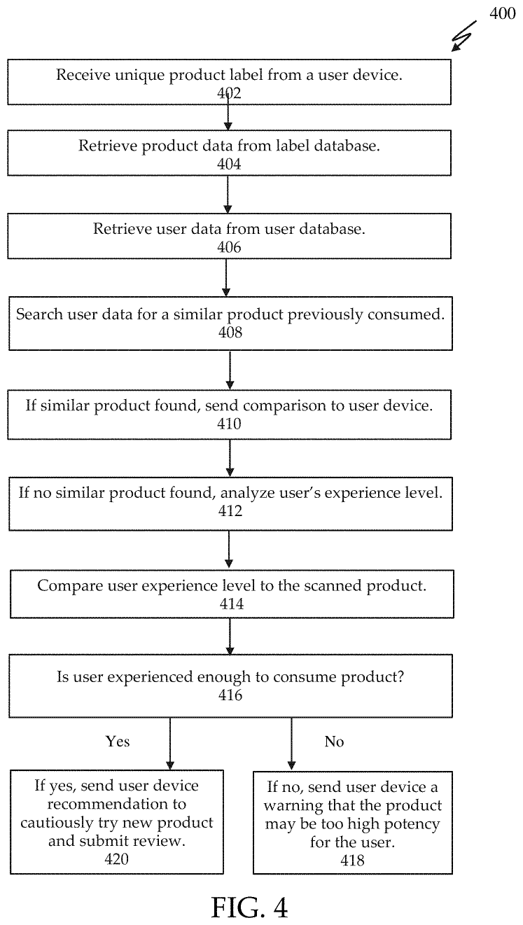

FIG. 4 is a flowchart illustrating an exemplary method 400 for comparing the onset of effects. The label network 102 receives a unique product code when a user scans a product label 124 using the barcode scanner 116 of the user device 114 at step 402. The label network 102 then retrieves product data from label database 104 by matching the unique product code with the product in the label database 104 at step 404. The label network then retrieves the user data from the user database 110 by matching user ID with the user in the user database 110 at step 406. The user data may include the experience level of users, product previously consumed or reviewed, etc. at step 406. The label network 102 may also search the user data for a similar product previously consumed at step 408. Similar products may include products of similar levels of cannabinoids, a similar delivery format (e.g. edible, vaporizer, smoking, etc.), or come from a similar product manufacturer. In some embodiments, a similar product may have also been reviewed by a similar type of user who has also reviewed a product that the current user has previously consumed (e.g. a user with comparable physical size and comparable amount and type of usage).

If a similar product was found, the comparison module 108 will send the comparison to the user device 114 at step 410. The comparison may include the similarities and differences between the previously consumed product and the current product. If no similar product is found, the comparison module may analyze user's experience level stored in the user database at step 412. The user's experience level may be based on self-reported tolerance, inferred from the products the user has previously reviewed or usage data stored in the user profile. The comparison module 108 may then compare user experience level to the scanned product based on potency, or experience level of other users who have consumed the Cannabis product, at step 414.

The comparison module 108 will then analyze whether the user is experienced enough to consume product at step 416. For example, the module will analyze whether the user's experience level is the same or greater than the experience level recommended for the product. If the user is not experienced enough, the comparison module 108 will send a warning to the user device 114 that the product may be inappropriate for the user at step 418. In an embodiment, the warning may specify that the product potency may be too high for the user. In another embodiment, the warning may suggest alternative similar products with lower potency for the user to consume. If the user has the appropriate experience, the comparison module 108 will send a recommendation to the user device 114 to cautiously try the new product and submit a review at step 420.

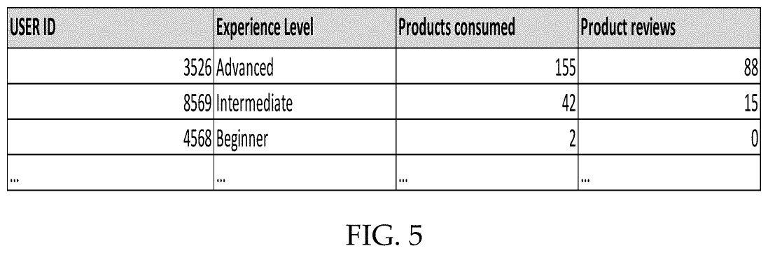

FIG. 5 is a table illustrating exemplary user data that may be included in the user database 110. The database may include for each user their user ID, experience level, history of Cannabis usage, and previously submitted reviews that may include descriptions of the onset of effects of Cannabis products. For example, in table 5, the first user is identified with user ID 3526. User 3526 has an advanced experience level, a reported history of 155 incidents of product consumption, and has submitted 88 product reviews.

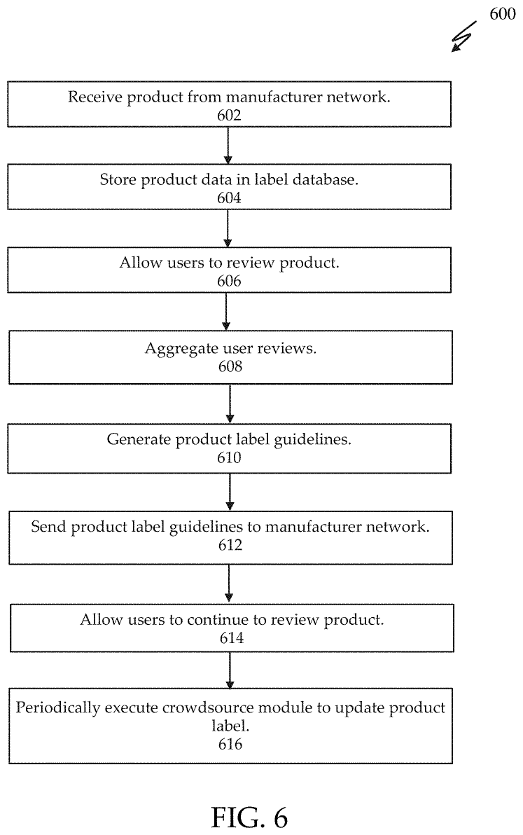

FIG. 6 is a flowchart illustrating an exemplary method 600 updating the onset of effect descriptions through communications with the manufacturer. First the label network 102 receives product data from manufacturer network 134 at step 602. The product data may include health and safety information, cannabinoid concentration, suggested use, etc. Next, the label network 102 stores the product data in label database 104 at step 604. Users are then allowed to access and review the product via the crowdsource module 106 at step 606. The reviewing method may be conducted in various ways. For example, the users may be a random focus group, a team of expert reviewers, or general users who have agreed to test a product. The crowdsource module 106 then aggregates the user reviews using statically methods at step 608. The aggregation and reporting of the user reviews may be accomplished through various ways such as through a mean average, common words used to describe the product, and user experience level. The label network 102 uses the reviews to generate the product label guidelines at step 610. The guidelines may include time until onset of effects, time until dissipation of effects, user experience level, subjective sensation, appropriate activities during consumption, etc. Next, the label network 102 will send the product label guidelines to the manufacturer network 134 to be reviewed by the manufacture of the product at step 612. The users may continue to review the product at step 614. The crowdsource module 106 may periodically execute to aggregate the uploaded reviews to send updated product guidelines to the manufacturer at step 616.

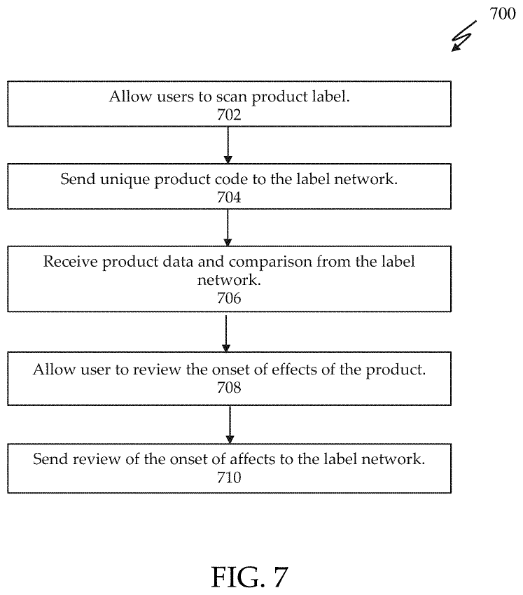

FIG. 7 is a flowchart illustrating an exemplary method 700 for the user to access and upload descriptions of the onset of effects. First, the label scanner 116 on the user device 114 allows a user to scan a product label 124 at step 702. Then the network module 118 sends the unique product code to the label network 102 and user ID for product comparison at step 704. The label network 102 receives the product data and initiates the comparison module 108 to analyze the product and sends that data back to the user device 114 at step 706. A comparison analysis may include reviewing the onset of effects, reviewing other user reviews, and comparison with other similar product that the user has previously consumed, or a recommendation based on the user's experience level. The user may submit a review of the onset of effects of the product on the user device 114 at step 708. The review may include the time from consumption to the onset of effects, time for the effects to dissipate, and other features of the subjective experience of the user. The final step is for the network module 118 to transmit the review of the onset of effects to the label network 102 at step 710.

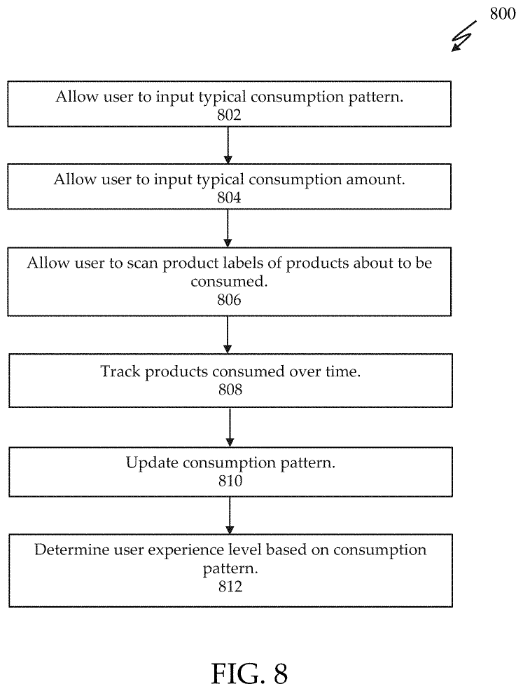

FIG. 8 is a flowchart illustrating an exemplary method 800 for the user to track their consumption of Cannabis products. First, the user may input their typical consumption pattern (e.g. daily, weekly, monthly) via the usage module 120 at step 802. The user may then input typical consumption amount (e.g., 0.5 grams), via the usage module 120 at step 804. The user may then scan the product label of the product about to be consumed at step 806. Once the user has inputted the information and the product has been scanned, the usage module 120 will collect and track the products consumed over time at step 808. The user may continuously update their consumption pattern at step 810. The final step is to determine user experience level based on consumption pattern at step 812.

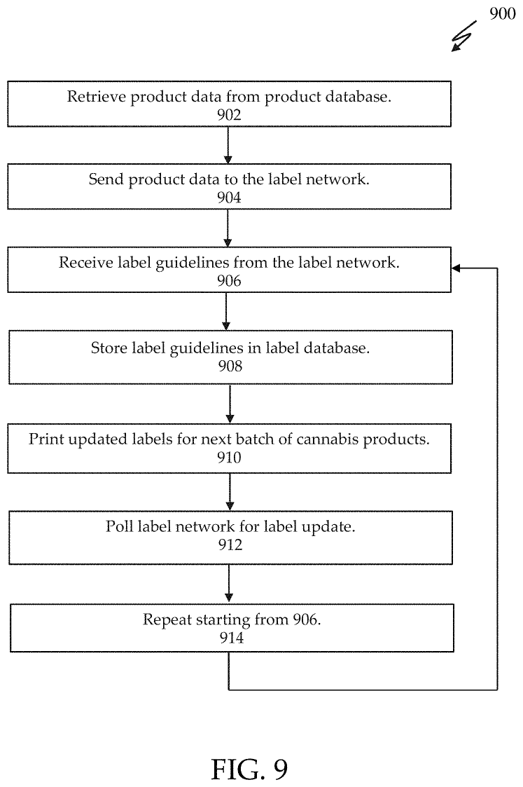

FIG. 9 is a flowchart illustrating an exemplary method 900 for updating the manufacturer's product label. First, the label module 138 retrieves product data from product database 136 at step 902. Next, the manufacturer network 134 sends the product data to the label network 102 at step 904. The label module 138 then receives the label guidelines from the label network 102 at step 906. The manufacturer network 134 stores the label guidelines in the label database 140 at step 908. The manufacturer may then print the labels, or updated labels, for the next batch of Cannabis products at step 91. After a label has been created, the label module 138 may also update the manufacturer labels by polling the label network 102 for label update at step 912. At step 914, the manufacturer network 134 may then repeat from step 906 to receive any updated guidelines.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claims.

What is claimed is:

1. A method of updating dynamic labels for Cannabis products, the method comprising:
receiving an image of a dynamic label affixed to a Cannabis product, wherein the dynamic label includes at least a portion that is unique to the Cannabis product and provides a product profile for the Cannabis product;
accessing a plurality of user profiles stored in a memory of a label network, each user profile including one or more attributes regarding a respective user;
receiving, via the label network, a new review regarding consumption of the Cannabis product by at least one of the users, wherein the new review is associated with the user profile;
updating the product profile for the Cannabis product based on the new review and the attributes included in the user profile of the at least one user; and
updating a label database of the label network based on the updated product profile, wherein a next scan of the dynamic label results in the updated product profile being provided from the label database.

2. The method of claim 1, further comprising tracking consumption of the Cannabis product by the at least one user, and storing data regarding the tracked consumption with cross-reference to the associated user profile and the updated product profile.

3. The method of claim 1, further comprising identifying that the Cannabis product shares one or more common attributes with at least one other Cannabis product, and sending an alert to the user device regarding the identified similarity to the at least one other Cannabis product.

4. The method of claim 1, further comprising receiving data regarding the Cannabis product from a manufacturer, wherein generating the updated product profile is further based on the received data from the manufacturer.

5. The method of claim 1, wherein scanning the dynamic label includes imaging a scannable bar code indicative of a type of Cannabis product.

6. The method of claim 5, further comprising receiving a subsequent review for the Cannabis product from another one of the users, wherein the subsequent review is associated with a scan of the bar code.

7. The method of claim 1, wherein the attributes of the at least one user include an experience level, and further comprising identifying a recommended experience level for the Cannabis product based on the experience level of the user as indicated by the associated user profile, wherein the label database accessible via the scanned dynamic label includes the recommended experience level.

8. The method of claim 1, wherein the review is indicative of one or more effects of the Cannabis product, and wherein the label database accessible via the dynamic label includes a description of the effects.

9. The method of claim 1, wherein a plurality of reviews are received, each review including a factor rating for the Cannabis product, and further comprising generating an average factor rating, wherein the dynamic label includes the factor rating.

10. The method of claim 9, wherein the reviews are associated with different experience levels, and wherein the factor rating is averaged for each experience level.

11. The method of claim 9, further comprising receiving subsequent review that results in an updated average factor rating, and updating the dynamic label when the updated average factor rating exhibits at least a threshold level of change.

12. The method of claim 1, further comprising transmitting the updated label database to one or more manufacturers of the Cannabis product, and continuously updating label guidelines for the Cannabis product, wherein identified updates are also transmitted to the manufacturers.

13. The method of claim 1, further comprising receiving product data from a manufacturer of the Cannabis product, wherein generating the updated product profile is further based on the received product data from the manufacturer.

14. The method of claim 13, wherein the received data includes testing data regarding the Cannabis product.

15. The method of claim 14, further comprising of comparing the testing data regarding the Cannabis product to data regarding at least one other Cannabis product, wherein generating the updated product profile is further based on the comparison.

16. The method of claim 15, wherein the comparison is indicative of a match between the Cannabis product and the at least one other Cannabis product, and further comprising updating the updated product profile of the at least one other Cannabis product based on the indicated match.

17. The method of claim 15, wherein the comparison is indicative of a difference between the Cannabis product and the at least one other Cannabis product further comprising transmitting the indicated difference to the manufacturer.

18. The method of claim 1, further comprising generating an aggregate rating based on the product data and the user profile, wherein the dynamic label includes the aggregate rating.

19. A system of updating dynamic labels for Cannabis product, the system comprising:
a label network operable to receive an image of a dynamic label affixed to a Cannabis product, wherein the dynamic label includes at least a portion that is unique to the Cannabis product and provides a product profile for the Cannabis product;
a user database stored on the label network, wherein the user database stores a plurality of user profiles, each user profile including one or more attributes regarding a respective user;
a communication network interface that transmits a new review regarding consumption of a Cannabis product by at least one of the users to the label network, wherein the new review is associated with the user profile; and
a processor that executes instructions stored in memory, wherein the processor executes instructions to:
generate an updated product profile for the Cannabis product based on the new review and the attributes included in the user profile of the at least one user; and
update a label database stored on the label network based on the updated product profile, wherein a next scan of the dynamic label provides the updated product profile from the label database.

20. A non-transitory, computer-readable storage medium, having embodied thereon a program executable by a processor to perform a method of updating dynamic labels for Cannabis products, the method comprising:
receiving an image of a dynamic label affixed to a Cannabis product, wherein the dynamic label includes at least a portion that is unique to the Cannabis product and provides a product profile for the Cannabis product;
accessing a plurality of user profiles stored in a memory of the label network, each user profile including one or more attributes regarding a respective user;
receiving, via the label network, a new review regarding consumption of a Cannabis product from at least one of the users, wherein the new review is associated with the user profile;
updating the product profile for the Cannabis product based on the new review and the attributes included in the user profile of the at least one user; and
updating a label database of the label network based on the updated product profile, wherein a next scan of the dynamic label provides the updated product profile from the label database.
